(19) United States
(12) Patent Application Publication
(10) Pub. No.: US 2014/0067802 A1
(43) Pub. Date: Mar. 6, 2014

(54) META DATA DRIVEN FEED ARCHITECTURE

(71) Applicant: Vaideeswaran Prabhakar, Boxboro, MA (US)

(72) Inventor: Vaideeswaran Prabhakar, Boxboro, MA (US)

(73) Assignee: FMR LLC, Boston, MA (US)

(21) Appl. No.: 13/602,538

(22) Filed: Sep. 4, 2012

(51) Int. Cl. G06F 17/30

(52) U.S. Cl. 707/736; 707/E17.005

(57) ABSTRACT

A feed management system is provided that includes a first application module receiving from a user a plurality of fields for processing. The first application module reads meta data from one or more database servers so as to form configuration data for extracting information from the one or more database servers. A generic feed program receives the configuration data and invokes a plurality of extractions of feed data from the one or more database servers. The generic feed program generates one or more feed files associated with the extractions of feed data.

### BACKGROUND OF THE INVENTION

The invention is related to the field of feed management, and in particular to a feed management architecture that would eliminate custom point to point data feed programs.

Sharing of data between systems using files is still prevalent in back office operations. Distributed systems manage data in relational databases like Oracle, Sybase and DB2. However, these distributed systems share the data they manage with other systems, especially mainframe systems and with systems outside of the business unit using file feeds. Whenever data sharing is to be enabled between systems, a custom feed program is developed to extract the required data set from the database, written to a file in a predefined format and the file is posted to the target system for use. The complexity of the feed management is in the order of n² with each system writing a custom point to point feed program to share data with another system.

### SUMMARY OF THE INVENTION

According to one aspect of the invention, there is provided a feed management system. A first application module receives from a user a plurality of fields for processing. The first application module reads meta data from one or more database servers so as to form configuration data for extracting information from the one or more database servers. A generic feed program receives the configuration data and invokes a plurality of extractions of feed data from the one or more database servers. The generic feed program generates one or more feed files associated with the extractions of feed data.

According to another aspect of the invention, there is provided a method of generation a plurality feeds using the single instance of a generic feed program. The method includes receiving from a user a plurality of fields for processing. Using a first application module, meta data is read from one or more database servers so as to form configuration data for extracting information from the one or more database servers. Receiving the configuration data, the generic program invokes a plurality of extractions of feed data from the one or more database servers, the generic feed program generates one or more feed files associated with the extractions of feed data.

According to another aspect of the invention, there is provided a feed management system. The feed management system includes a first phase that allows a user to input a plurality of fields that is provided to a first application module as input. The first application module uses information from the fields to read meta data from one or more database servers so as to form configuration data for extracting information from the one or more database servers. The second phase generates a signal that informs a generic feed program to invoke a plurality of extractions of feed data from the one or more database servers. The generic feed program generates one or more feed files associated with the extractions of feed data.

### BRIEF DESCRIPTION OF THE DRAWINGS

FIG. 1 is a schematic illustrating a configuration using a number of custom feed programs for generating feeds;

FIG. 2 is schematic diagram illustrating an inventive feed development process used in accordance with the invention; and

FIG. 3 is a schematic diagram illustrating how to configure a feed process.

### DETAILED DESCRIPTION OF THE INVENTION

The invention involves a generic and simple architecture/solution for generating feeds. The proposed architecture eliminates custom feed development for each of the downstream feed specification. The invention intends to reduce the feed management complexity with a meta data driven feed architecture. Using the invention, the complexity of the feed management would drop from n(n−1) to n where n is the number of systems sharing data using the feeds.

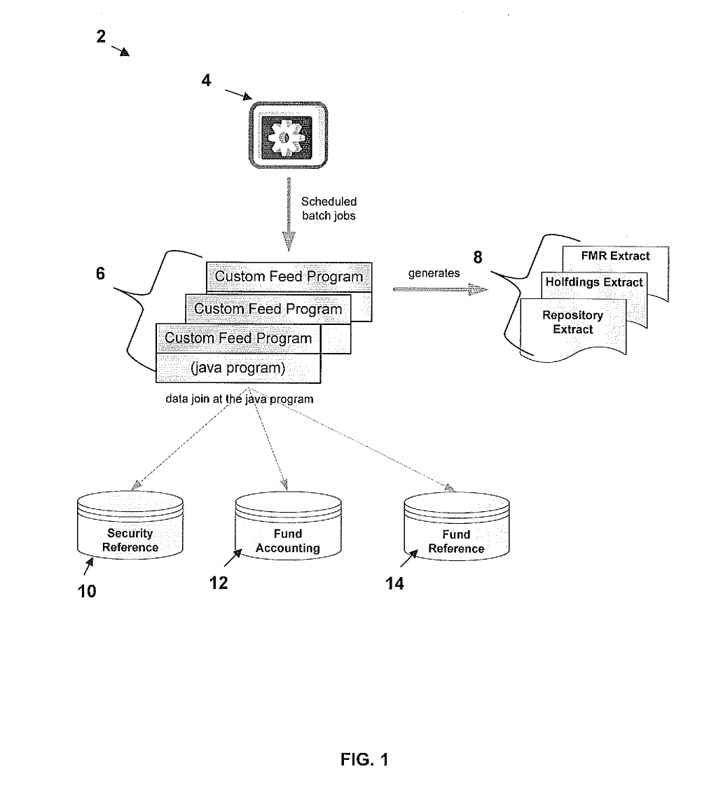

FIG. 1 shows a conventional custom feed extraction configuration 2 using a number of custom feed programs 6 for generating feeds for scheduled batch jobs using a batch job scheduling unit 4. Whenever a data feed is required, a custom feed program 6 is written to extract the required data for each particular database server structure 10, 12, 14, written to corresponding files 8 and then the files 8 can be transferred to the consumer using FTP/SFTP. Data is collected from various subject areas and joined together within the custom feed program 8.

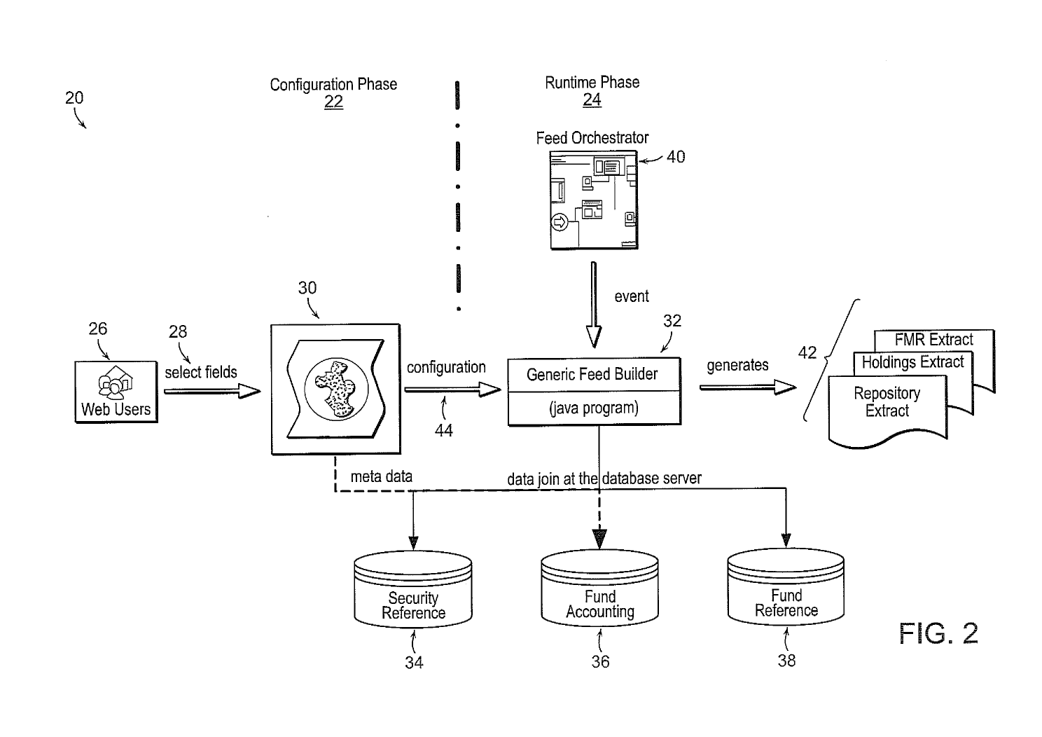

FIG. 2 shows an exemplary feed development configuration 20 used in accordance with the invention. The feed development configuration 20 involves two distinct phases: a configuration phase 22 and a runtime phase 24. First in the configuration phase 22, a new feed extract is configured using a web application 30. A user 26 selects the corresponding fields 28 needed to process. The web application 30 reads the meta data from database servers 34, 36, 38 and presents the fields 28 of the canonical model of the subject areas so as to create a custom SQL view that extracts the selected fields from the canonical models and packages this information as configuration data 44. The database servers include a security reference database 34, fund accounting database 36, and fund reference database 38. The web application 30 also can gather other relevant information about the feed to produce the configuration data 44. The configuration data 44 gathered acts as input to the runtime phase 24.

The configuration file 44 represents the precise structure of the database servers 34, 36, 38, and in more robust implementations, the data, such that the corresponding database servers 34, 36, 38 can be reconstructed when remote and disconnected therefrom. The configuration file 44 also contains information on the database type system, as well as views that are exposed by the database servers 34, 36, 38. Thus, the web application 30 prepares the meta data for mapping to other data models used by the database servers 34, 36, 38. The mapping can be between an Object component and/or the XML component, as an example.

Meta data generally contains information about the content that would allow the user or system to learn about the content without actually experiencing it. Also, meta data also enables the generation of a table of upcoming or currently running media content to allow the user or system to view, record, or does something else with the content such as filter, ignore, or block it. Meta data can include comprehensive text about the content including start time, stop time, program name, year released, business glossary, definition of the views for data access or the like. Note there are dozens of such fields, all of which are well understood in the art. The invention normalizes the content into a canonical form for later retrieval and in the extraction process to be further described herein. A generic feed builder program 32 acts on the configuration data 44 generated in the configuration phase 22 in the runtime phase 24. A feed orchestrator 40 produces an event that starts the generic feed builder program 32. Feed orchestrator 40 ensures data is ready for extraction and the feed runtime is ready to proceed. Once the data is ready, orchestrator signals the feed runtime to start the data/feed extraction. Orchestrator and feed runtime are loosely coupled and typical communication between them is through messages posted on a message queue.

The generic feed builder program 32 is involved in starting of a new job; creating the header record, and invoking the custom view to extract the feed data. In this case, the data joins happen at the database servers 34, 36, 38.

The invention provides the creation of a feed that involves configuration work and batch job development, and there is no Java or SQL code development, as produced by the user. The user is not required to provide extra code for this process. There are SQL joins involved to get the data elements for a subject area because the inventive canonical model is the denormalized record for the subject area. For example, the fund reference database 38 can include numerous tables. If one were to extract the data from these tables, such extractions would require multiple joins to get the desired fields. The canonical model used by the invention eliminates this need for multiple joins at runtime, thus producing time and cost savings.

There is one instance of the generic feed builder program 32 for each feed extraction. Also, the generic feed builder program 32 generates the feed files 42 after extraction has been performed. The generic feed builder program 32 can be easily extended to add any special or complex feed calculations or any custom formatting. The web application can include applets or other web applications modules that aid in retrieving metadata as well.

For the illustrated exemplary embodiment, it is assumed flat record structures are used for the feed files 42, but other file structures can be used. A canonical (denormalized) model along with data exist for each subject area: fund reference, security reference, general ledger, positions, or any data extracted.

The feed process used by the invention can allow a user to configure how data is arranged as well as what data is used in a user friendly context.

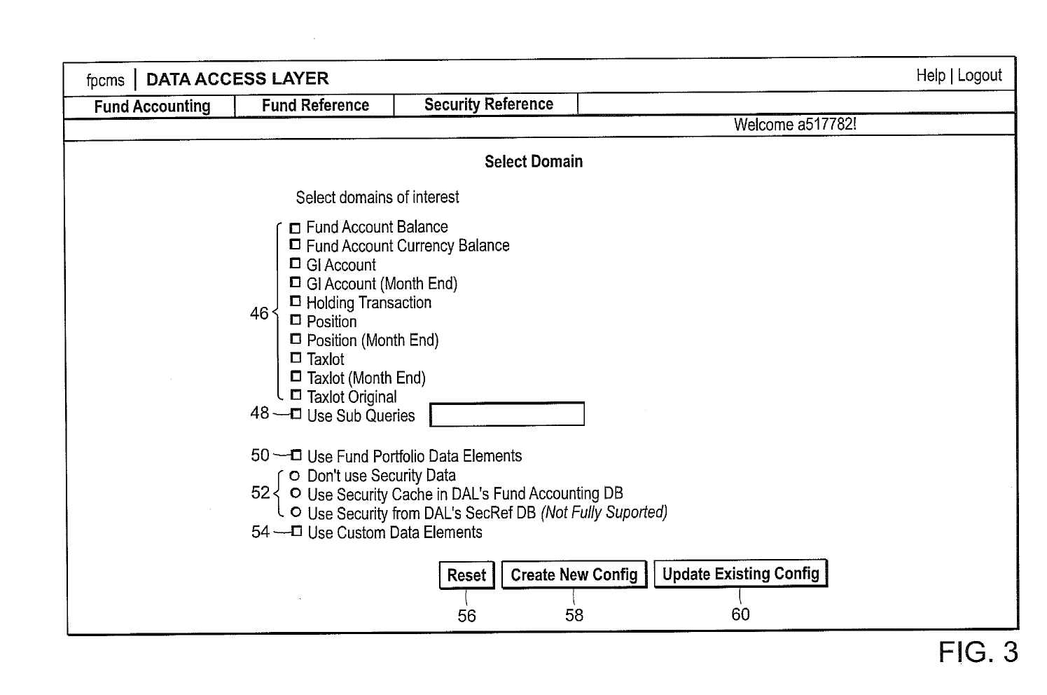

FIG. 3 is a schematic diagram illustrating how to configure a feed process. The feed process requires a user to select the appropriate data for processing. There are a number of fields the user selects to fulfill this task. In particular, domain fields 46 are provided allowing for the selection of domains to include in the final feed. Also, a sub queries field 48 provides the user a way of entering previously generated configuration as sub query, if desired. A fund portfolio data element field 50 provides the user the option of including data elements from the fund portfolio. Security data options fields 52 provide the user a set of options relating to security data. The user can choose not to use security data, to use the security cache in the Fund Accounting DB, or to use security information from the SecRef DB. Custom data elements fields 54 provide a way of entering custom data elements if the elements desired are not included in a predefined domain. A reset field 56 resets the form so that all options are unselected. A create new configuration field 58 begins the configuration creation process with the selected domains included. An update existing configuration field 60 only appears if the user chooses to edit an existing configuration. This will update the feed being edited to include the domains selected.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, for example, a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The invention can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system (for example, a cloud-computing system) that includes any combination of such back-end, middleware, or front-end components.

Communication networks can include one or more packet-based networks and/or one or more circuit-based networks in any configuration. Packet-based networks can include, for example, an Ethernet-based network (for example, traditional Ethernet as defined by the IEEE or Carrier Ethernet as defined by the Metro Ethernet Forum (MEF)), an ATM-based network, a carrier Internet Protocol (IP) network (LAN, WAN, or the like), a private IP network, an IP private branch exchange (IPBX), a wireless network (for example, a Radio Access Network (RAN)), and/or other packet-based networks. Circuit-based networks can include, for example, the Public Switched Telephone Network (PSTN), a legacy private branch exchange (PBX), a wireless network (for example, a RAN), and/or other circuit-based networks. Carrier Ethernet can be used to provide point-to-point connectivity (for example, new circuits and TDM replacement), point-to-multipoint (for example, IPTV and content delivery), and/or multipoint-to-multipoint (for example, Enterprise VPNs and Metro LANs). Carrier Ethernet advantageously provides for a lower cost per megabit and more granular bandwidth options.

Devices of the computing system can include, for example, a computer, a computer with a browser device, a telephone, an IP phone, a mobile device (for example, cellular phone, personal digital assistant (PDA) device, laptop computer, electronic mail device), and/or other communication devices. The browser device includes, for example, a computer (for example, desktop computer, laptop computer, mobile device) with a world wide web browser (for example, Microsoft® Internet Explorer® available from Microsoft Corporation, Mozilla® Firefox available from Mozilla Corporation).

The web application 30 in this exemplary embodiment of the invention is platform independent and can execute in any browser such as Firefox®, Internet Explorer®, or Chrome®. The web applicant can also be written in any platform independent-base computer language, such as Java or the like. The user selects the necessary fields by a check box or other methods commonly known in the art. The web application 30 executes on a client computer using a processor or the like. The web application 30 can be stored in the RAM or ROM of the client. The web application 30 can be stored in the RAM or ROM of the client. Furthermore, the web application 30 can be stored on an external memory device to be uploaded to the client computer for execution. The elements associated with the runtime phase 24, such as the generic feed program 32 and feed orchestrator 40, can be executed from the client computer or on a remote server. The elements 32, 40 can also be written in any platform independent-base computer language, such as Java or the like. The database servers 34, 36, 38 can be local on the client computer or on the remote server, as well as on a system remote from either the client computer or remote server. The client computer, remote server, and database servers communicate to each other using known communication protocols, such as TCP/IP.

The invention provides a generic and simple architecture/solution for generating feeds that eliminates custom feed development for each of the downstream feed specification. The invention reduces the feed management complexity from n(n−1) to n where n defines the number of systems sharing data using file feeds. The invention collects data from different subject areas and uses a generic feed builder program to perform query-based joins on the data. Moreover, the invention can be scheduled to run routinely at a specified time requiring very little user interaction or time.

Although the present invention has been shown and described with respect to several preferred embodiments thereof, various changes, omissions and additions to the form and detail thereof, may be made therein, without departing from the spirit and scope of the invention.

What is claimed is:

1. A feed management system comprising:
a first application module that receives from a user a plurality of fields for processing, the first application module reads meta data from one or more database servers so as to form configuration data for extracting information from the one or more database servers, wherein the configuration data represents the precise structure of the one or more database servers as well as the data from the one or more database servers so as to permit the first application to build a meta data model for feeds; and
a generic feed program that resolves the feed meta data model and invokes a plurality of extractions of feed data from the one or more database servers, to generate one or more feed files associated with the extractions of feed data, the generic feed program uses the feed meta data model to extract data from the one or more database servers, the feed meta data model includes denormalized representations of the extracted data minimizing access across disparate database platforms.

2. The management system of claim 1, wherein the first application module comprises a web based application.

3. The management system of claim 1, wherein the configuration data comprises SQL custom views used in the extractions of feed data.

4. The management system of claim 1, wherein the first application module comprises a canonical model for performing multiple joins at the one or more database servers.

5. The management system of claim 1, wherein the generic feed program receives an event from a feed orchestrator to perform the extractions of feed data.

6. The management system of claim 1, wherein the feed orchestrator ensures data is ready for extraction.

7. The management system of claim 1, wherein the first application module and the generic feed program execute in different phases of the feed management system.

8. The management system of claim 7, the first application module executes in the configuration phase of the feed management system.

9. The management system of claim 7, the generic feed program executes in the runtime phase of the feed management system.

10. The management system of claim 7, the first application module and generic feed program are platform independent.

11. A method of generation a plurality feeds using the single instance of a generic feed program:
receiving from a user a plurality of fields for processing,
using a first application module, meta data is read from one or more database servers so as to build a data feed meta data model for extracting information from the one or more database servers, wherein the feed meta data model represents the precise structure of the feed and its associated feed parameters that are necessary to resolve data for feed generation;
receiving the feed meta data model, the generic program invokes a plurality of extractions of feed data from the one or more database servers, the generic feed program generates one or more feed files associated with the extractions of data.

12. The method of claim 11, wherein the first application module comprises a web based application.

13. The method of claim 11, wherein the configuration data comprises SQL custom views used in extraction.

14. The method of claim 11, wherein the first application module comprises a canonical model for performing multiple joins at the one or more database servers.

15. The method of claim 11, wherein the generic feed program receives an event from a feed orchestrator to perform extraction.

16. The method of claim 11, wherein the feed orchestrator ensures data is ready for extraction.

17. The method of claim 11, wherein the first application module and the generic feed program execute in different phases of the feed method.

18. The method of claim 17, the first application module and generic feed program are platform independent.

19. A feed management system comprising:
a first phase that allows a user to enter a plurality of fields that is provided to a first application module as input, the first application module uses information from the fields to read meta data from one or more database servers so as to build a data feed meta data model for extracting information from the one or more database servers, wherein the feed meta data model represents the precise structure of the feed and its associated feed parameters that are necessary to resolve data for feed generation; and
a second phase that receives the configuration from the first phase, the second phase generates a signal that informs a generic feed program to invoke a plurality of extractions of feed data from the one or more database servers, the generic feed program generates one or more feed files associated with the extractions of feed data, the generic feed program uses the feed meta data model to extract data from the one or more database servers, the feed meta data model includes denormalized representations of the extracted data minimizing access across disparate database platforms.

20. The management system of claim 19, wherein the first application module comprises a web based application.

21. The management system of claim 19, wherein the configuration data comprises SQL custom views used in the extractions of feed data.

22. The management system of claim 19, wherein the first application module comprises a canonical model for performing multiple joins at the one or more database server.

23. The management system of claim 19, wherein the generic feed program receives the signal from a feed orchestrator to perform the extractions of feed data.

24. The management system of claim 19, wherein the feed orchestrator ensures data is ready for extraction.

25. The management system of claim 19, the first application module and generic feed program are platform independent.
